(19) United States
(12) Patent Application Publication
(10) Pub. No.: US 2022/0366372 A1
(43) Pub. Date: Nov. 17, 2022

(54) SYSTEM AND METHOD FOR HARVESTING MANAGERIAL INTELLIGENCE FROM A MESSAGE STORE

(71) Applicants: Terrance Tomkow, Los Angeles, CA (US); Zafar Khan, Redondo Beach, CA (US)

(72) Inventors: Terrance Tomkow, Los Angeles, CA (US); Zafar Khan, Redondo Beach, CA (US)

(21) Appl. No.: 17/662,341

(22) Filed: May 6, 2022

Related U.S. Application Data
(60) Provisional application No. 63/201,856, filed on May 15, 2021.

(51) Int. Cl. G06Q 10/10

(52) U.S. Cl. CPC G06Q 10/107

(57) ABSTRACT

A System and Method for the analysis of messages sent and received by a plurality of employees of an organization by applying techniques of natural language processing to messages sent and received through an organization messaging systems, servers, retained on message archives, or in a proprietary message archive. Stored or messaging system processed messages are subjected to content and sentiment analysis and the results are displayed in a graphical user interface in a manner which provides managerially useful information.

### BACKGROUND

Modern enterprises rely on electronic messaging systems for their internal and external communications. These messages systems include email, SMS text messages, chat systems like Skype™ and Discord™ as well as collaboration systems such as Slack™ and Microsoft Teams™. Numerous state and federal regulations require that many enterprises must retain copies of all such messages transmitted and received by the organization for extended periods of time and that they be retained in a manner that facilitates search, discovery and production of those messages for litigation and regulatory compliance. For examples, the table below records s sample of some of the Federal email retention regulations in the United States for information relevant to their area of oversight.

| EMAIL RETENTION LAW | GOVERNS | DURATION | |
|---|---|---|---|
| IRS Regulations | All Companies | 7 | Years |
| Freedom of Information Act | Federal, State, and local | 3 | years |
| (FOIA) | agencies | | |
| Sarbanes Oxley Act (SOX) | All public companies | 7 | years |
| Department of Defense | DOD contractors | 3 | years |
| (DOD) | | | |
| Federal Communications | Telecommunications | 2 | years |
| Commission (FCC) Regulations | companies | | |
| Federal Deposit Insurance | Banks | 5 | years |
| Corporation (FDIC) Regulations | | | |
| Food and Drug Administration | Pharmaceutical firms, | From 5 to | |
| (FDA) Regulations | food manufacturers, food | 35 years | |
| | storage and distribution | | |
| | firms, manufacturers of | | |
| | biological products | | |
| Gramm-Leach-Bliley Act | Financial Institutions | 7 | years |
| Health Insurance Portability and | Healthcare organizations | 6 | years |
| Accountability Act (HIPAA) | | | |

The European Union's General Data Protection Regulation imposes similar requirements.

These requirements have created a need for systems that continuously store all messages transmitted and received internally and externally by the organization in a way that makes them searchable and retrievable. That need has been met by many different message storage systems, services and devices.

Heretofore, the purchase and maintenance of such message archiving systems and services has been an overhead cost with no benefits beyond compliance with legal requirements. The present disclosure describes a system which allows an organization to use the data from its message archive as a powerful management tool.

Further, management efforts to gain employee insight are often done overly using surveys sent by email. This creates an overload on staff not only completing a lot of surveys, but also by staff in companies to create these surveys, distribute them, and analyze the results manually relying on the staff's perhaps not always honest completion of reviews with concern that they may be perceived as a dissenter if there are associated with negative reviews on a particular initiative. Another challenge with this approach is IT staff need to make others aware of the distinction between good email with links to click sent from managers in the company versus (which originate from external sources if survey tools are used) versus imposter email send from cyber criminals posing as those same managers.

Additionally, there are tools using “net promotor score” techniques to understand the sentiment of customers related to a product. These are relying on the user taking action and providing honest feedback scoring overall enthusiasm based on a 1 to 10 score card. This disclosure can provide for a sentiment analysis on replies from customers to correspondence send from customer representatives, increasing the network of sentiment analysis to external parties interacting with staff internal company parties. Additionally, manager have concerns in companies with not having time to review all of the “CC” and “BCC” copy email that they receive. To minimize their risk, a view of the sentiment analysis of the CC/BCC email that they receive will provide them insight into how to priorities review of certain CC/BCC messages, limiting liability without having to review all for the CC and BCC email.

The above are particularly useful for change management and project management staff to get early warnings on success or potential problems and sentiment related to workflow changes and project status. After a workflow change, managers can gauge success and use the overall sentiment post-change over time as a tangible and measurable project success metric.

Risk and compliance departments can measure sentiment across teams and/or business groups or business divisions/entities to create a chart of overall human-centric risk (risk of staff retention, lawsuits, positive or negative word-of-mouth, or positive or negative workplace environments.

The present disclosure satisfies these and other needs.

### SUMMARY OF THE INVENTION

In its most general aspect, the disclosure is applicable to organizations that operate message retention, message filtering, or other systems that can review content of messages and documents that are part of messaging services and systems used by a plurality of employees. It is further assumed that employees of said organizations will have, as a condition of employment, contractually eschewed claims and expectations of privacy for the content of messages sent over the organization's proprietary messaging systems and acknowledged the organization's right to audit said messages.

The present disclosure comprises systems and methods whereby an organization can data mine messages to and from its employees to gain managerial intelligence. Managerial intelligence is the study of attitudinal information (i.e., information about how employees regard their jobs, their employers and their co-workers) and of communication content and connectivity (i.e. what employees are talking about and with whom).

Over the past several decades a variety of techniques have been developed for the algorithmic analysis of the semantic content and emotional tone of natural language text messages. These techniques can determine with a high degree of accuracy the subject matter and the sentiments expressed in messages. The present disclosure describes systems and methods whereby these techniques might be applied to an organization's message archive to provide its managers with intelligence about the flow of information within the organization, the efficiency of collaboration among the organization's personnel and subdivisions, topics of concern and stress within the organization as well as interpersonal conflicts and grievances.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

Other features and advantages of the present disclosure will become apparent from the following detailed description, taken in conjunction with the accompanying drawings, which illustrate, by way of example, the principles of the disclosure.

### BRIEF DESCRIPTION OF THE DRAWINGS

The drawings accompanying and forming part of this specification are included to depict certain aspects of the disclosure. A clearer impression of the systems and methods of the disclosure, and of the components and operation of systems provided with the disclosure, will become more readily apparent by referring to the exemplary, and therefore nonlimiting, embodiments illustrated in the drawings, wherein identical reference numerals designate the same components.

FIG. 1 is a schematic diagram of a computer or processing system that may be specifically modified by the various embodiments of the present disclosure.

FIG. 2 is a schematic diagram of a network used in accordance with the various embodiments of the disclosure.

FIG. 3 is a block diagram illustrating the information topology of one embodiment of the disclosure.

FIG. 4 illustrates one embodiment of a graphical user interface providing a sentiment mapping of an organizations message traffic.

FIG. 5 illustrates one embodiment of a graphical user interface providing sentiment analysis of an organizations message traffic by a specific keyword.

FIG. 6 illustrates a graphical user interface displaying a particular message with sentiment markup and controls for tuning the analytical system.

FIG. 7 illustrates a graphical user interface displaying the volume and sentiments of messages exchanged among different divisions of an organization.

FIG. 8 illustrates a graphical user interface displaying connectivity internally and externally in an organization division.

FIG. 9 illustrates an interface which allows users to create and maintain dictionaries of keywords for natural language and sentiment processing.

### DETAILED DESCRIPTION OF THE PREFERRED EMBODIMENTS

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Detailed descriptions of known natural language processing techniques, computer software, hardware, operating platforms, and protocols are omitted so as not to unnecessarily obscure the disclosure in detail. Various substitutions, modifications, additions and/or rearrangements within the spirit and/or scope of the underlying inventive concept will become apparent to those skilled in the art from this disclosure.

The techniques of natural language processing are well documented in the prior art and are constantly evolving and improving. The present disclosure does not require or rely on any particular embodiment of such systems but assumes that any such system will employ some form of machine learning which tunes the accuracy of system outputs in response to user feedback. Accordingly, the described embodiments incorporate methods for users to train the processor by scoring its analysis.

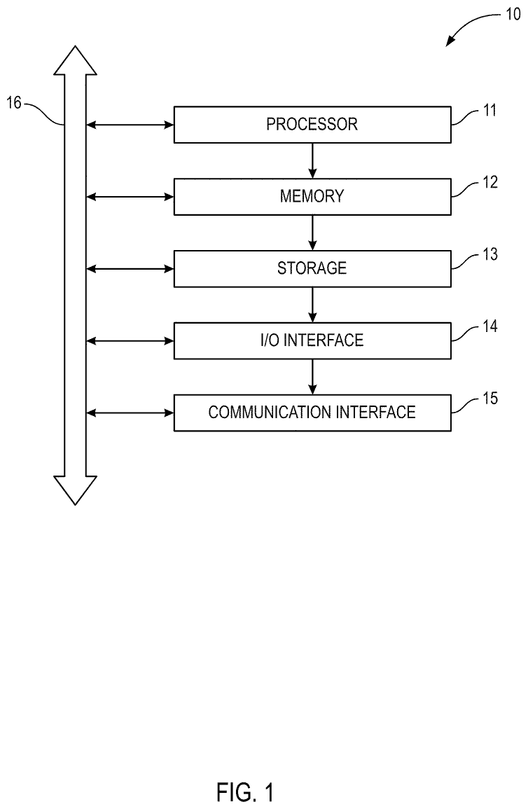

FIG. 1 illustrates an exemplary computer system 10 which may be used with some embodiments of the present disclosure, which may be, for example, a server or a client computer system. Computer system 10 may take any suitable form, including but not limited to an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, etc. Computer system 10 may be a combination of multiple forms. Computer system 500 may include one or more computer systems 10, be unitary or distributed spanning multiple locations, spanning multiple systems, or residing in a cloud (which may include one or more cloud components in one or more networks).

In one embodiment, computer system 10 may include one or more processors 11, memory 12, storage 13, an input/output (I/O) interface 14, a communication interface 15, and a bus 16. Although this disclosure describes and illustrates a particular computer system having a particular number of particular components in a particular arrangement, this disclosure contemplates other forms of computer systems having any suitable number of components in any suitable arrangement.

In one embodiment, processor 11 includes hardware for executing instructions, such as those making up software. Herein, reference to software may encompass one or more applications, byte code, one or more computer programs, one or more executable modules or API, one or more instructions, logic, machine code, one or more scripts, or source code, and or the like, where appropriate. As an example and not by way of limitation, to execute instructions, processor 11 may retrieve the instructions from an internal register, an internal cache, memory 12 or storage 13; decode and execute them; and then write one or more results to an internal register, an internal cache, memory 12, or storage 13. In one embodiment, processor 11 may include one or more internal caches for data, instructions, or addresses. Memory 13 may be random access memory (RAM), static RAM, dynamic RAM, or any other suitable memory. Storage 15 may be a hard drive, a floppy disk drive, flash memory, an optical disk, magnetic tape, or any other form of storage device that can store data (including instructions for execution by a processor).

In one embodiment, storage 13 may be mass storage for data or instructions which may include, but not limited to, a Hard Disk Drive (HDD), Solid-State Drive (SSD), disk drive, flash memory, an optical disc (such as a DVD, CD, Blu-ray, and the like), magneto-optical disc, magnetic tape, or any other hardware device which stores computer-readable media, data and/or combinations thereof. Storage 13 maybe be internal or external to computer system 10.

In one embodiment, input/output (I/O) interface 304 includes hardware, software, or both for providing one or more interfaces for communication between computer system 10 and one or more I/O devices. Computer system 10 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, trackpads, biometric input device or sensor, or the like.

In still another embodiment, a communication interface 15 includes hardware, software, or both providing one or more interfaces for communication between one or more computer systems or one or more networks. Communication interface 15 may include a network interface controller (NIC) or a network adapter for communicating with an Ethernet or other wired-based network or a wireless NIC or wireless adapter for communications with a wireless network, such as a Wi-Fi network. In one embodiment, bus 16 includes any hardware, software, or both, coupling components of a computer system 10 to each other.

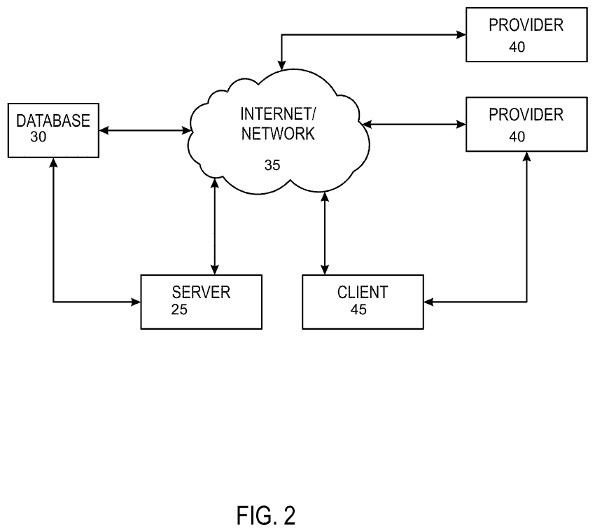

FIG. 2 is a graphical representation of an exemplary network 20 that may be used to facilitate the various embodiments of the present disclosure. Server 25 is operated by a services organization, and typically includes at least one processor, input and output equipment or devices, memory, storage, and a communication interface, as discussed above with regards to FIG. 1. The server also operates under the control of specialized software programming commands that are designed to carry out the various processes described above. It should be understood that while the exemplary network 20 is described in terms of a server operated by a services organization, the server could be operated by a third party hired by the services organization or under the control of the services organization. The server could also be operated by a third party independent of the services organization, which then provides information and/or data to the services organization from which the services organization may provide services to a client of the services organization.

A data storage device 30, which may be separate from the server, but not necessarily, may be accessible to the server 25, and may be used for storing data related to information and any other data related to operation of the various embodiments of the system and method described above. The data storage device 30 may be directly connected to the server, or it may be accessible to the server through a network or the Internet 35. The data storage device may also be a virtual storage device or memory located in the Cloud. Also connected through the network or the Internet 35 are one or more providers 40 or a client 45.

From the above, while it may be apparent that the various embodiments disclosed herein may be implemented by computers, servers, or other processors that appear to be organized in a conventional distributed processing system architecture, the various embodiments disclosed herein are not conventional because they bridge multiple remote information sources, such as legacy computer applications, legacy storage media and data resident on workstation storage, media, and also involve sophisticated analysis of various parts of an email message, as well as the methods, protocols, and communication pathways used to transmit and receive the email message. When the various embodiments of this disclosure are operated using computers, servers, and processors, those embodiments transform those computers, servers, and processors into specially programmed computers, servers, and processors in a way that improves not only the operation of the various hardware and software components of the system, but also significantly improve the transmission, receipt, and processing of email messages.

For the purposes of the disclosure, there are technologies known by those skilled in the art, and the methods of implementing the disclosure will use technology components commonly used by those skilled in the art, and this description of the disclosure, therefore, does not describe these component technologies. These include the use of:
1. Sender mail client
2. Sender mail server
3. Sender mail gateway
4. Email content filtering
5. Secure messaging service servers
6. Secure transmission protocols
7. Email encryption methods and protocols
8. Database logging and association
9. RPost Registered Email service technology (patented)
10. RPost Registered Receipt authentication service technology (patented)
11. Hashing, Digital Signature, and Block Chain technologies
12. RPost SideNote service technology (patented)
13. Recipient mail gateways
14. Recipient mail servers
15. Recipient mail clients such as Microsoft Outlook or Gmail
16. Parts of a message
   a. Message headers
   b. Message content
17. Message transmission protocols, including secure message transmission protocols
18. Data reports provided by email
19. Web views of data reports
20. Encryption and authentication processes and protocols
21. Replies to received electronic messages
22. Use of software tools to extract content and create images of the content
23. Use of tools to create content that may be associated with HTML links, and self-extracting HTML links inserted into an email
24. Associating information in databases
25. Operating software on web and email servers

The term “email” used herein may refer to any electronic message type; the term “ email protocol” may refer to any electronic data exchange protocol, and the term “electronic file” may refer to any file type.

The various embodiments described herein may be implemented as a whole or only in select parts. For the purpose of this disclosure, consider implementing for each part, in one embodiment, of which there are others that a skilled practitioner would identify as within the spirit of the disclosure.

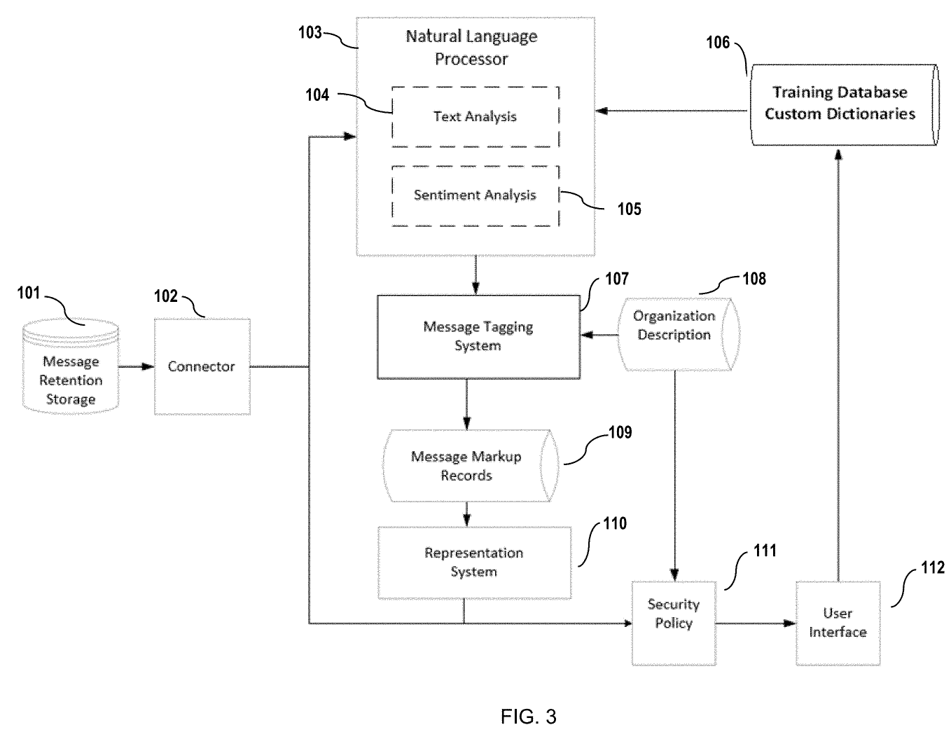

FIG. 3 is a diagrammatic representation of one embodiment of the present disclosure in an organization with a message retention archive 101. Since the present disclosure may be implemented in organizations which already operate some form of message archiving and these systems may differ in the form of messages stored and their manner of storage a Connector unit 102 is provided to extract information from the archive and transmit it to the system in a standard format. The Connector is a software customizable system that can be adapted to different message storage systems.

The connector harvests messages in bulk from the storage archive and transmits them to a Natural Language Processing system 103 (NLP) which analyzes each message separately. The Natural Language Processing system includes a Text Analysis component 104 which evaluates the semantics of each message to determine the primary topics of the messages and the actions described. The results of these analysis are rendered as lists of keywords associated with each message. This semantic analysis is based upon customizable dictionaries 106 which record the ontologies and actions relevant to the activities of the organization.

The Natural Language Processing system also includes a Sentiment Analysis Processor 105 which assigns a numerical score to each message significant of the sentiments expressed in the message. A negative score indicating a negative emotion and positive score indicating positive emotions. The Sentiment Analysis is based on a semantic analysis of the message and draws on dictionaries assigning emotional weighting to lexical elements in context. By means well known to practitioners of the art, these weights and the algorithms that sum them are adjusted by user feedback on the accuracy of their results. This allows users of the system to train the Natural Language Processer to produce increasingly accurate results.

For each message input to the NLP the processor will generate a plurality of data points which will include the time of the message, addresses of the sender and recipients, lists of keywords that occur in the message and a sentiment score. These data points are provided to a Message Tagging System 107 which will record them in association with a unique identifier for the message that will allow the original message content to be retrieved from the Message Retention Store via the connector. In addition, the message tagging system will draw on an Organization Description component 108 which will identify the sender and recipients of each message by their names, titles, and roles in the organization.

The message tagging system stores its output in a database of Message Markup Records 109. This database will allow message records to be searched by sender, recipient, keywords and sentiment score.

Drawing on the Message Markup Records a Representation System 110 creates graphical representations and data summaries of message data.

In any organization, access to the message data store must be strictly controlled. A Security Policy system 111 allows the organization to determine which agents of the organization may access message information. The policy may be predicated on the organization's hierarchy, chain of command, departmental responsibility or linked to particular keywords. Message information may also be anonymized for some users.

Users authorized by the Security Policy will have access to multiple representations of the message data through a User Interface 112 which is designed to suit the interests and needs of organization managers.

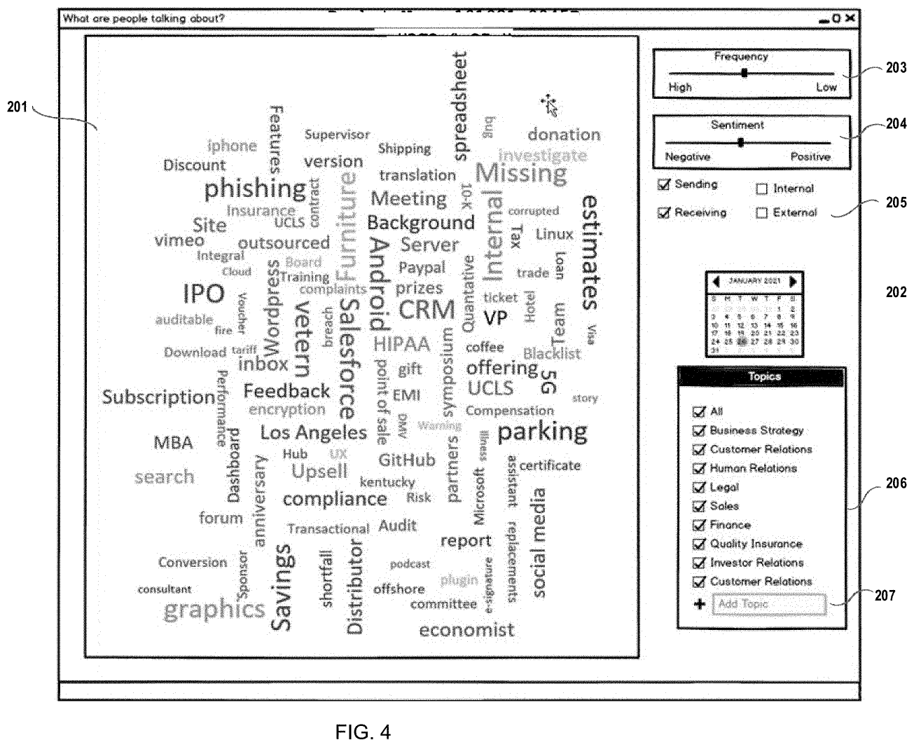

FIG. 4 depicts an embodiment of the disclosure which displays the output of text and sentiment analysis in a word cloud 201. In this embodiment, the size of words in the cloud indicates their relative frequency in the message corpus; the orientation of the words indicates whether the words occur more, on average, in past, present or future tense contexts; the color or shade of the words indicates the average sentiment of the context of the word's occurrence; the vertical position of the words is indicative of the average rank of the message source relative to the organizational hierarchy.

The selector 203 allows the user to filter the represented words by the frequency of their occurrence in the message corpus.

The selector 204 allows the user to filter the represented words by their sentiment scores.

The controls 205 allow the user to filter the represented worlds by date or restricted to messages sent or received and/or restricted to messages sent within the organization or externally.

The selector 206 allows the user to filter the represented words by categories described in a stored dictionary correlating key words with topic. The control 207 allows the user to edit the topic categories.

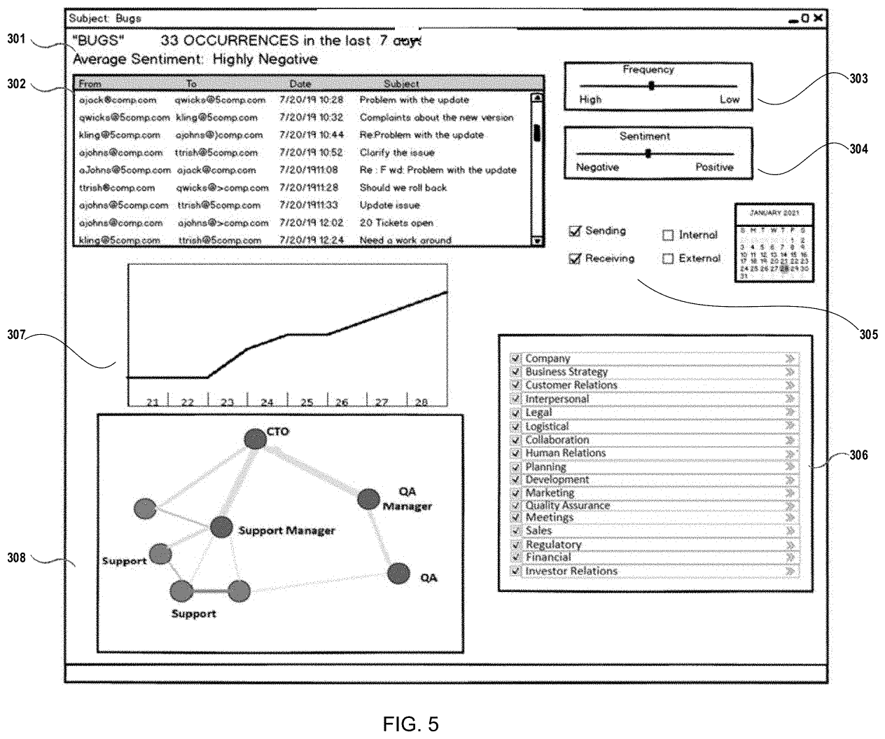

In this embodiment, clicking on any word in the cloud invokes the display depicted in FIG. 5.

FIG. 5 displays information for a selected word occurring in the message store. The display records 301 the number of occurrences of the word over a selected period and the average sentiment of the messages in which it occurs.

A selectable list of the messages identified by sender, destination, date and subject is displayed 302.

A selector 303 allows the user to filter the messages list 302 for frequency of recurrence.

A selector 304 allows the user to filter the message list 302 for the messages' sentiment score.

The controls 305 allow the user to filter the represented worlds by date or restricted to messages sent or received and to messages sent within the organization or externally.

The selector 306 allows the user to filter the represented words by categories described in a stored dictionary correlating key words with topic.

The graph 307 displays the frequency of occurrence of the selected word in the message corpus as a function of time.

The network graph 308 displays the individuals or organization units that have exchanged messages containing the selected word. The thickness of the connecting line between nodes being indicative of the relative frequency of the selected word occurring in the messages between the parties. The color or shading of the connected lines being indicative of the sentiment.

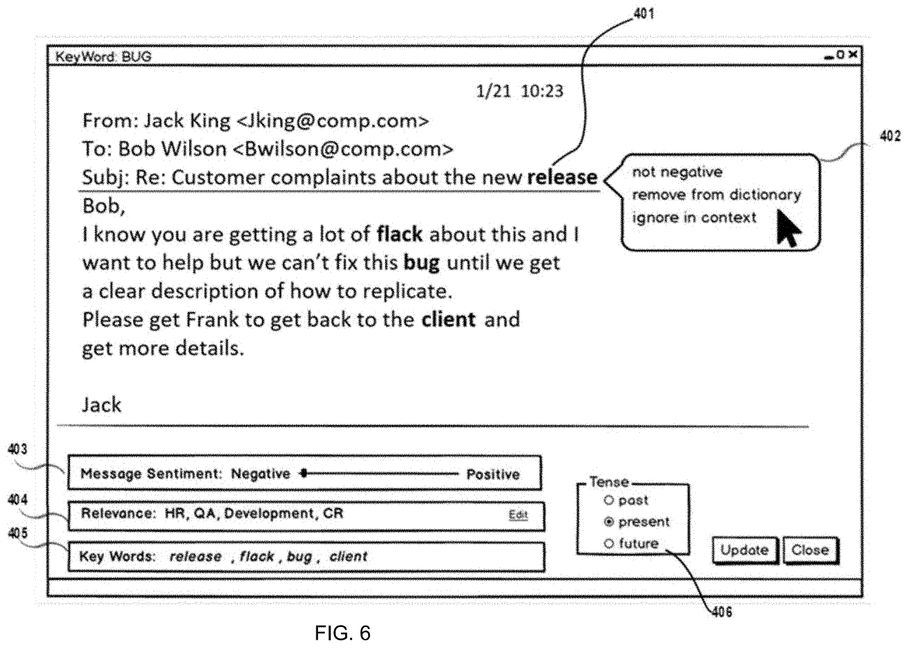

In this embodiment, selecting any message in the message list 302 invokes displays the whole of message in a manner illustrated by FIG. 6.

FIG. 6 illustrates the display of a message, retrieved by the Connector system from the message store. The display of the message is augmented to highlight the occurrence of keywords 401 with the size, font or color being used to indicate the sentiment value the NLP system has assigned to this occurrence of the word.

Selecting a word in the message offers the user a menu 402 which the user can use to evaluate the NLP evaluation of the word in context. The user's verdicts are recorded by the system to train the NLP's analysis algorithms.

The selector 403 displays the NLP's analysis of the message's sentiment score. By adjusting this selector, the user can tune the NLP's sentiment analysis algorithm.

The field 404 displays the topics the NLP has determined are relevant to the messages. By editing this list, the user can train the NLP to better recognize relevance to topic.

The field 405 displays the dictionary keywords found in the message.

The selector 406 displays the NLP's determination of whether the message concerns the past, present or future. By adjusting this selector, the user can train the NLP's determination of tense.

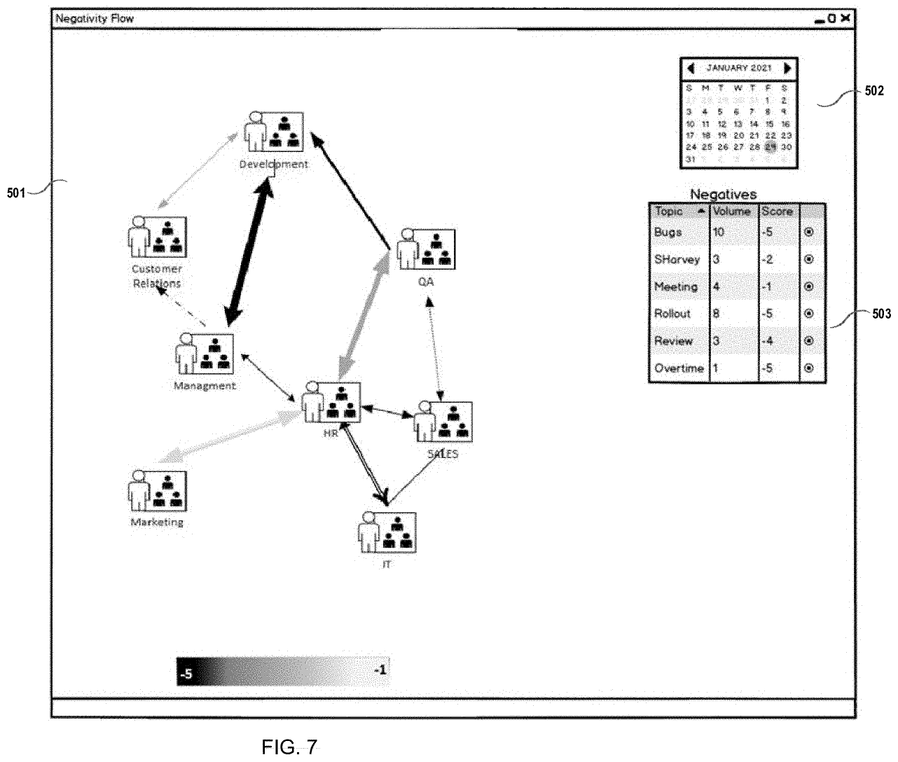

FIG. 7 illustrates another method by which sentiment across the organization might be graphically displayed. In the network diagram 501 reports an analysis of the message traffic between different departments of the organization. The width of the connections illustrates the volume and direction of traffic and shading or color indicating the average sentiment score of the traffic.

The control 502 selects the date for analysis.

The selector 503 shows the frequency of negative sentiment keywords occurring in the traffic and allows the user to filter out particular words from the analysis.

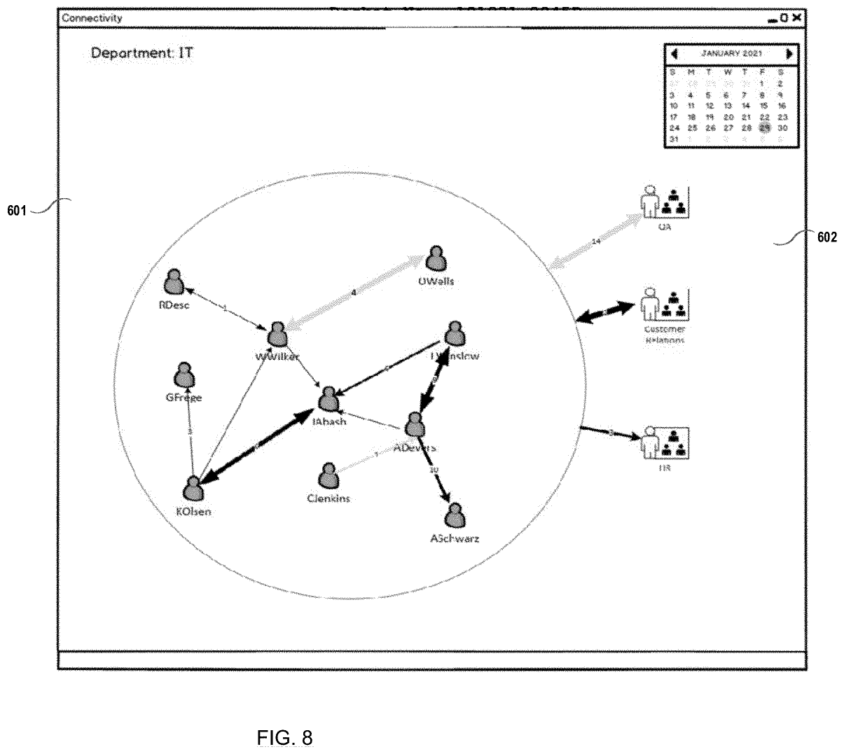

The graphical interface depicted in FIG. 8 illustrates how the disclosure might be useful to a manager in assessing the overall efficiency of communication within the organization. The network diagram 601 displays the flow of traffic within a particular division of the organization and its connectivity with other divisions 602.

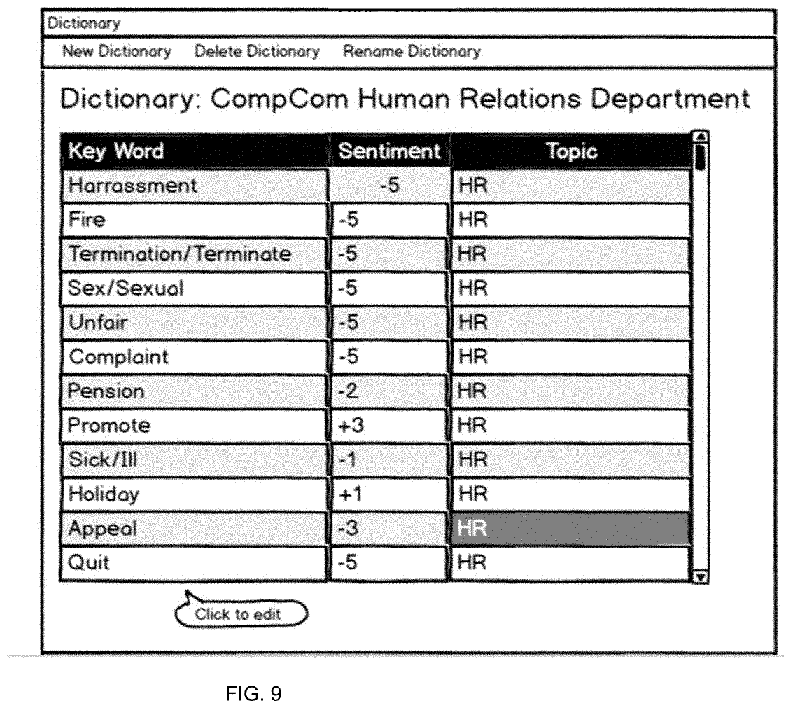

Different organizations and different divisions of a single organization will wish to interrogate the message store about different topics and will give different sentiment scores to keywords. FIG. 9 displays a sample interface in which a user of the disclosure can edit a selected dictionary of keywords and sentiment weights.

While particular embodiments of the present disclosure have been described, it is understood that various different modifications within the scope and spirit of the disclosure are possible. The disclosure is limited only by the scope of the appended claims.

I claim:

1. A system for extracting managerial intelligence from a collection of messages sent and received by employees of an organization comprising:
a processor programmed using hardware and software programming commands to:
apply natural language processing to each message in a collection of messages sent and received by employees of an organization to generate a list of words representing topic objects and actions referenced in each message,
apply techniques of algorithmic sentiment analysis to assign a value to the message associated with the sentiment expressed by the message, and
aggregating this value to provide managers with summary information about the connexity, content and sentiment of the messages.

2. The system of claim 1, wherein the processor is further programmed to comply lists of words recurring in the collected messages ranked in order of frequency and of the sentiment value of the messages in which they occur.

3. The system of claim 1, wherein the processor is further programmed to measure a quantity of messages exchanged between employees of the organization.

4. The system of claim 1, wherein the processor is further programmed to measure the sentiment of messages sent to individual employees of the organization.

5. The system of claim 1, wherein the processor is further programmed to measure the sentiment of messages sent from individual employees of the organization.

6. The system of claim 1, wherein the processor is further programmed to measure the sentiment of messages sent to selected groups of employees of the organization.

7. The system of claim 1, wherein the processor is further programmed to measure the sentiment of messages sent from selected groups of employees of the organization.

8. The system of claim 1, wherein the processor is further programmed to measure the quantity of messages sent to or from selected groups of employees of an organization.

9. The system of claim 1, wherein the processor is further programmed to measure the sentiment of messages exchanged between selected employees or groups of employees of the organization.

10. The system of claim 1, wherein the processor is further programmed to sort messages by their sentiment evaluation.

11. The system of claim 1, wherein the processor is further programmed to examine the content of messages.

12. The system of claim 1, wherein the processor is further programmed to assign values to lexical elements to adjust sentiment valuations.

13. The system of claim 1, wherein the processor is further programmed to compile dictionaries of lexical elements to be measured.

14. The system of claim 1, wherein the processor is further programmed to adjust the sentiment evaluation metrics by users.

15. The system of claim 1, wherein the processor is further programmed to control access to the data produced by the system in accordance with an accessor's managerial role.

16. The system of claim 1, wherein the processor is further programmed to anonymize message senders or recipients.

17. The system of claim 1, wherein the processor is further programmed to produce network diagrams depicting the flow of message information within the organization.

18. The system of claim 1, wherein the processor is further programmed to produce network diagrams depicting the sentiment of messages exchanged within the organization.

19. The system of claim 1, wherein the processor is further programmed to produce network diagrams depicting the exchange of messages with a selected subject matter within the organization.

20. The system of claim 1, wherein the processor is further programmed to produce word cloud diagrams depicting the frequency of particular words in the message collection or selected subsets of that collection using word orientation, color and/or font to indicate the sentiment and tense of the messages in which the words occur.

21. A computer system for extracting managerial intelligence from a collection of messages sent and received by employees of an organization comprising:
a processor;
a storage device connected to the processor, wherein the storage device has stored thereon copies of messages transmitted to and from the employees of the organization; and
a natural language processing system coupled to the processor and capable of identifying the topics and sentiments of messages in the message store and returning data records of occurring keywords and sentiment scores for each message; and
wherein the processor collates said data records to generate reports which describe the connexity, content and sentiment of the messages.

22. The system of claim 21, wherein the processor compiles lists of words recurring in the collected messages ranked in order of frequency and of the sentiment value of the messages in which they occur.

23. The system of claim 21, wherein the processor records the quantity of messages exchanged between employees of the organization.

24. The system of claim 21, wherein the processor records the sentiment of messages sent to individual employees of the organization.

25. The system of claim 21, wherein the processor records the sentiment of messages sent from individual employees of the organization.

26. The system of claim 21, wherein the processor records the sentiment of messages sent to selected groups of employees of the organization.

27. The system of claim 21, wherein the processor records the sentiment of messages sent from selected groups of employees of the organization.

28. The system of claim 21, wherein the processor records the quantity of messages sent to or from selected groups of employees of the organization.

29. The system of claim 21, wherein the processor records the sentiment of messages exchanged between selected employees or groups of employees of the organization.

30. The system of claim 21, wherein the processor ranks messages by their sentiment evaluation.

31. The system of claim 21, providing means to examine the content of messages.

32. The system of claim 21, including an interface which permits users to manipulate the assignment of variables which control sentiment valuations.

33. The system of claim 21, including an interface which allows users to create dictionaries of lexical elements to be measured.

34. The system of claim 21, including an interface which allows users to adjust the sentiment evaluation metrics.

35. The system of claim 21, wherein user access to data is restricted in accordance with the user's managerial role.

36. The system of claim 21, wherein message data is anonymized.

37. The system of claim 21, wherein the processor provides a user interface displaying network diagrams depicting the flow of message information within the organization.

38. The system of claim 21, wherein the processor provides a user interface displaying network diagrams depicting the sentiment of messages exchanged within the organization.

39. The system of claim 21, wherein the processor provides a user interface displaying network diagrams depicting the exchange of messages with a selected subject matter within the organization.

40. The system of claim 21, wherein the processor provides a user interface displaying word cloud diagrams depicting the frequency of particular words in the message collection or selected subsets of that collection using word orientation, color and/or font to indicate the sentiment and tense of the messages in which the words occur.

41. The system of claim 21, wherein the processor provides a user interface displaying word cloud diagrams depicting the frequency of particular words in the message collection or selected subsets of that collection using word orientation, color and/or font to indicate the sentiment and tense of the messages in which the words occur, and by mode of communication (i.e. email, text/sms, chat, etc.)

42. The system of claim 21, wherein the processor provides a user interface displaying word cloud diagrams depicting an analysis of facial expressions and other context in images (including emoji) appended to messages.

43. A computer system for extracting managerial intelligence from a collection of messages sent and received by employees of an organization comprising:
a processor; and
a message filtering device connected to the processor, wherein the copies of messages transmitted to and from the employees of the organization; and
a natural language processing system coupled to the processor and capable of identifying the topics and sentiments of messages in the message store and returning data records of occurring keywords and sentiment scores for each message; and
wherein the processor collates said data records to generate reports which describe the connexity, content and sentiment of the messages.
